(19) United States
(12) Patent Application Publication
(10) Pub. No.: US 2020/0168184 A1
(43) Pub. Date: May 28, 2020

(54) Instrument musical ergonomique et chromatique

(71) Applicant: Damien Bernard, Amboise (FR)

(72) Inventor: Damien Bernard, Amboise (FR)

(21) Appl. No.: 16/686,465

(22) Filed: Nov. 18, 2019

(30) Foreign Application Priority Data
Nov. 28, 2018 (FR) FR1871962

(51) Int. Cl. G10D 7/03; G10G 5/00

(52) U.S. Cl. CPC G10D 7/03; G10G 5/005

(57) ABSTRACT

This presentation exposes the invention of a fully chromatic single-pipe wind instrument, without any mechanisms or keys, capable of covering a register of three octaves. This instrument can take two different forms, the flute form or the saxophone form.

The concept is an ergonomic configuration of construction which allows to obtain equal playing freedom for the ten fingers of the musician and the physical balance of the instrument by the combination of two material factors: firstly a support added to the body of the pipe which is gripped by one hand in the hollow between the thumb and forefinger, and secondly an ergonomic arrangement of the finger holes on both sides of the pipe to strengthen the overall balance.

The objective of this invention is to bring together two qualities which seem hitherto incompatible: on the one hand the possibility of easily playing all the semi-tones of the chromatic scale on a large range, and on the other hand the possibility to play cursive ornementation (pitch continuity in between notes) as well as with semi-rhythmic ornamentation.

For the musician, the interest is to play freely in any tonality without constraints, in particular without using the common half-hole fingerings of flutes and keyless saxophones, and to be able to invest in the tonal world the expressive field of keyless instruments techniques, whether semi-rhythmic ornamentation or cursive ornamentation.

### INTRODUCTION

This presentation exposes the invention of a single pipe wind instrument that is both completely direct fingering and totally chromatic, covering a three octave range. Here we use the adjective direct fingering to express the direct contact of the musician's fingers on the finger holes of the wind instruments. Direct fingering therefore means in this presentation absence of keys and absence of mechanisms.

The invention can be applied in two forms of instrument: the flute (generally cylindrical pipe section and edge-blown mouthpiece) and the saxophone (conical pipe section and reed mouthpiece), these two instruments sharing the same acoustic property of allowing an octave jump from the second register (note: here we use the term register in its restricted acoustic sense, designating a jump in the isolation of harmonic partials of a fundamental sound; this is what english language calls overblowing). The new instrument, in its flute or saxophone form, has exactly the same principle in its concept and in its configuration. We will therefore speak jointly of the two forms in this presentation which basically only presents one invention.

The concept of the new instrument is an ergonomic construction design. It allows equal playing freedom for the ten fingers and the physical balance of the instrument by the combination of two material factors which will be described in detail: on the one hand the presence of a support added to the body of the pipe which is supported by the hand distant from the mouthpiece (generally the right hand for instruments built right-handed) in the zone located between the thumb and the index finger, and on the other hand an ergonomic arrangement of the finger holes on either side of the pipe to strengthen the overall balance.

Regarding the pitch order from low to high, the holes are arranged on the first register following the chromatic order and the anatomical continuity of the fingers of each hand, each open finger corresponding to the raise of a semitone, without no fork fingering (note: fork fingering can be described as height corrections made by other fingers distant from an open hole under a given fingering; in general, for fluidity and ease of play, less an instrument requires fork fingerings, the better). The second and third octaves are obtained as usual for wind instruments by overblowing the second, third and fourth registers. That is to say that for a given fingering having its fundamental note, one obtains successively by overblowing the following notes: octave, fifth above the octave, and double octave. Due to the chromatic arrangement of the first register, the fingering of the new instrument thus differs completely not only from those of the classical flute and those of the saxophone, but also from those of all keyless wind instruments from around the world.

Besides, equal temperament is the most suitable tuning for the new instrument, and it is this tuning that we are implying in this presentation. However, this innovation being independent of the chosen temperament, it is not impossible to conceive an uneven temperament tuning for the new instrument in case of a specific musical approach. The result will work just as well, with this constraint of course that the uneven configuration chosen for a given tonality cannot be found identically on the other tonalities (note: this property is common to all musical instruments with unequal temperament).

Interest

In this presentation we call cursive the possibility for a wind instrument to play in continuous pitches from one note to another, which is sometimes also called glissando (note: the term glissando in western classical music generally describes an occasional ornament; in other musical cultures, in India in particular, playing nearly systematically on the sliding pitches between notes is part of a rich and very developed language, and we prefer in this case speak of cursive playing); We also call semi-rhythmic playing, the possibility for these same instruments to insert incisive and fast fingering ornamentations, a technique notably developed in many musical cultures in the world. English language often designates these latter ornaments by the words taps and cuts (note: these terms designate the ornamentation of a note either by a lower incision, or by a higher incision, which is commonly done in Celtic music in particular; other cultures develop these semi-rhythmic ornaments even more intensively (as for example Bulgarian and Turkish music).

The purpose of this invention is to join up two qualities which seem so far practically incompatible: on the one hand the possibility of easily playing all the semitones of the chromatic scale on a large range (3 octaves), and on the other hand the possibility of playing cursive as well as semi-rhythmic ornamentation. For the musician, the advantage is to be able to play freely in any key without constraints, in particular without using the very common half-hole fingerings (note: fingering in which a finger only partially covers a hole in order to obtain a desired pitch; difficult to control in fast playing, this type of fingering is therefore preferably to be avoided; in the present invention, however, one remains in the first register, which represents a note out of thirty six in the total of the three octaves, i.e. a very low ratio; this point will be discussed in the appendix to point Ten fingers for twelve semitones, the solution of the first register) of flutes and saxophones without keys, and to be able at the same time to bring up in a tonal music perspective all the expressivity of direct fingering techniques, whether semi-rhythmic ornamentation or cursive playing.

These two characteristics have not been combined to date in any wind instrument. On the one hand, traditional flutes, or types of keyless saxophones, whatever their origins in the world, do not allow to easily play all the semitones on a large range; on the other hand, key instruments such as the classical transverse flute or the saxophone do not allow the richness of the direct fingering ornamentation in the sense described above. The advantage of the present invention is to combine these two characteristics. (note: the Bulgarian Kaval, flute with 8 holes of play, is certainly in the world the traditional flute which comes closest to the complete chromatism, but if we look more precisely at this instrument we can easily see its chromatic gaps; other traditional flutes today like the Chinese dizi and the Japanese shakuhachi have modern versions with 10 finger holes to obtain a complete chromatism, but with great ergonomic constraints and fork fingerings from the first register; this is due to the fact that all these modern versions maintain the basis of the original fingering based on a diatonic scale, so that experienced musicians do not need to learn from the beginning a new fingering chart made just for covering few missing semitones here and there).

In addition, another advantage of the new instrument, perhaps limited to the range of the alto and soprano, would be to obtain the capacity and main results of the classical transverse flute—the Boehm flute—and the saxophone, without the construction disadvantages of the keys system. The advantage would be for the reduction in the weight of the instrument and its lower manufacturing cost. Although this is not the primary goal of our invention, however this potential interest has been the intention of very close innovative concepts in the past.

Historical Context

During a musical era very different from today, and responding to problems determined by historical context, similar concepts of this instrument have been apparently developed by at least three personalities. According to some sources, the concept of a chromatic and keyless flute was already considered and exposed by the German flutists J G Tromlitz and H W Pottgiesser around the 1800s (note: The Flute, Ardal Powell, Yale University Press, 2002, pages 146 and following). Aware of the embarrassment of key mechanics system, the Italian flautist Carlo Tommaso Giorgi took up this idea at the end of the 19th century, with the creation of a direct fingering and chromatic flute with an end-blown mouthpiece. Giorgi's intention was to dispense with the keys by covering all the semitones of the first register with each of the fingers of both hands, played directly on the body of the flute. On this instrument, the holes are arranged mainly on the upper and lower axes as in most conventional arrangements, with 7 holes on the axes and 4 holes outside the axes (note: the patent for the Giorgi flute is visible on the website of Australian flute maker Terry McGee at: www.mcgee-flutes.com/Giorgi-flute-patent.htm).

Great innovation in the idea to set up the finger holes of the first register as a continuum of semitones (one finger cover/uncover for one semitone), the models of Tromlitz, Pottgiesser and Giorgi do not however have an ergonomic arrangement of the finger holes that allows a sufficient balance of the instrument in the hands of the musician (note: as we will explain in the following points Necessary ergonomics and Ergonomic concept, strong ergonomics is a necessary condition without which the new instrument would not be playable in the sense of the practice of a professional musician). Furthermore, these models have no other material support than the fingers of the musicians themselves, which necessarily implies an overload of work for the thumb of the right hand (in the case of a right-handed flute). These are overall positions that are unfortunately not ergonomic, and instruments that are difficult to play or even impractical (note: speaking of the Giorgi flute, the American flautist and collector Rick Wilson mentions in his website www.oldflutes.com: “It can be difficult to support and play the instrument because the hand position and required stretch are not comfortable for many hands”). Actually, despite the immense interest of their idea, the keyless flutes of these three inventors have not been played by any professional musician since their creation.

These historical facts being little known, we did not discover them until we had built and practiced the instrument which is the object of this presentation. However, although neither Tromlitz, Pottgiesser nor Giorgi had any influence on the present invention, it seems to us worth recalling these old concepts, both as a mark of respect for innovative musicians, and to place this presentation in a broader perspective, recalling shared aspirations.

If the instrument presented here is therefore quite close to the initial ideas of Tromlitz, Pottgiesser and Giorgi, however its concept and technical configuration are very different.

Independence of the Acoustic Configuration

Considering its shape and its material, there is a relatively standard construction of saxophones in the world. But for flutes, there are a large number of instruments which vary greatly with regard to the shape of the mouthpiece, the size of the instrument, their internal diameter, the shape of the pipe (conical or cylindrical), the thickness of the wall, the material itself, the finish of the interior walls, etc. . . . . All these parameters influence the tone, the loudness, the ease of emission and many other aspects of the play, that we could summarize with the expression acoustic style of a flute.

Whether for the saxophone type or for the flute type, the new instrument is independent of these parameters. It is therefore compatible in principle with any acoustic style, whether for example for the flutes of a transverse flute (classical, dizi, venu, bansuri, . . . ), an end-blown flute with horizontal edge (shakuhachi, kena, Giorgi flute, . . . ), an end-blown flute with vertical edge (kaval, ney, . . . ), or other.

The only restriction, however, is related to the natural size of the hand, which influences the range. Most flutes in the world have a neighboring range, with a foot note generally chosen between C4 and E4 (often D4), which corresponds for an adult to the comfortable finger spacing average position of two hands on the body of the instrument. This range also best corresponds to the present invention. We can certainly look for a higher range by tightening the spacing of the fingers, but we will probably be quickly limited in lower ranges by the impossibility of spreading the fingers more than the anatomy of the hand allows, unlike to the flutes and saxophones with which a mechanic system of keys gives the advantage, by being declined in the tenor, baritone and others form, of extending far enough in the bass range.

Anatomical Continuity and Chromatic Scale

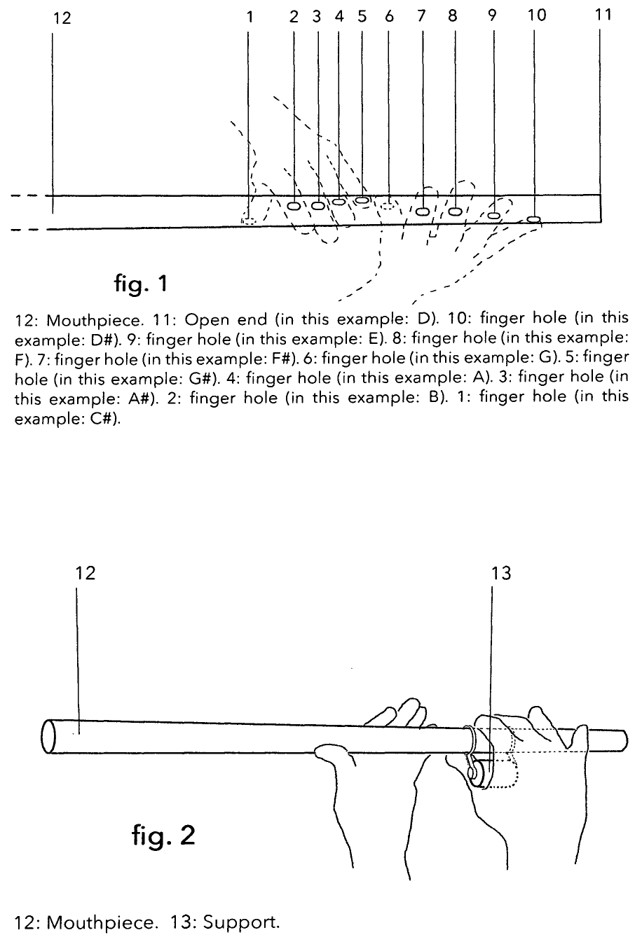

The new instrument is played directly respecting the adequacy between the anatomical continuity of the fingers and the chromatic scale of the semitones, which means one finger uncovering for one semitone raise—See [FIG. 1] of the Drawings section, which shows the example of a D4 foot tuning (note: the pipe in FIG. 1 is cylindrical, but it can also be conical as for the saxophone, the arrangement being exactly the same; unless otherwise indicated, this remark applies to all the following figures; for hole (1), it is a do # and not a do♮, this question of the jump of a whole tone will be discussed and explained in the Appendices at point Ten fingers for twelve semitones, the solution of the first register.

The disadvantage of this point is for the experienced musician to face an entirely new fingering chart. But on the other hand, there is a significant interest in approaching the ease of spatial intuition of pitch continuity, as found in the playing on a violin string for example, or on the piano keyboard, where all the fingers can rest in anatomical continuity on the scale of the semitones. Such a model is not an absolute reference, and many instruments with anatomical discontinuity of the fingers nevertheless allow to achieve excellent results in musical practice. However we consider that this continuity is a definite advantage. To make it easily understood, we can imagine, for example, a piano keyboard which few keys would be reversed in their right/left position, for example by reversing the position of B and A, F # and G #; the relationship with the anatomical continuity of the hand would thus be broken. Now, if this inversion would have been the native and traditional position of the keyboard, and if all the musicians had to learn through this arrangement from their beginnings, it is not difficult to imagine that they would have certainly also reached excellent results in term of musical performance. But, and pianists could surely confirm it, it seems preferable, in order to facilitate the ease of spatial intuition and its correlation with the pitch continuity, that the scale of semitones follows the anatomical continuity of the fingers; and this true for wind instruments as for keyboards.

Necessary Ergonomics

Every instrument assumes a more or less ergonomic configuration, that is to say adapted to the morphology of the human body. The more an instrument is ergonomic, the less it offers physical constraints for the musician and the more it allows the development of technical capacity, dexterity and virtuosity. In fact, no instrument is perfectly ergonomic, and every instrument involves physical constraints that the musician must manage. Even the piano, which is nevertheless one of the most ergonomic instruments, is not without physical constraints for the musician (height of the keyboard compared to the body of the musician, need to play seated, support of the suspended feet playing the pedals, layout and spacing of the keys, width and resistance of the keys, etc.). For the violin, an instrument for which one can achieve the greatest virtuosity, the constraint is quite significant: asymmetrical play at the level of the head for holding the instrument, support of the left hand under the neck to help stabilizing the instrument, possibly a support between the shoulder and the head, etc. . . . . In general, instruments which one carries with the arms while playing, like the violins or the wind instruments, always imply at a time or another of the practice, that fingers or parts of the hand temporarily take the role of supporting the weight and maintaining the balance of the instrument, during the execution of certain notes or transitions. This does not prevent musicians to play freely all the notes on these instruments. For the violin in particular, despite the ergonomic difficulties of support, this comes from the fact that all the notes are equally accessible on the strings.

In the case of keyless wind instruments like traditional flutes, this is not possible, since not all notes are equally accessible, and some require the use of the half-hole fingering. Even in the case of a modern ten-hole version of a traditional flute for which all the fingers are required, if there is no support other than the fingers of the hand and if the axis of most holes remains the upper axis of the pipe (as is the case with most 10-hole flutes including Giorgi's), the instrument will not be practicable on the long term. Indeed, when the weight support of certain fingers or groups of fingers is absent at a given moment (when they open the holes), especially when this group includes the thumb of the distant hand from the mouthpiece (the right hand for a flute constructed in right-hand), the remaining fingers support have great difficulty to keep everything in balance. Except if exaggerating the strength used by the remaining fingers, but this leads to stiffen muscles in a considerable part of the hands, thus to reduce the dexterity and fluidity of playing.

Ergonomic Concept

For the new instrument, the ergonomic position of the fingers is a particular position different from the classic position, including an offset between finger holes position and the upper and lower axes of the instrument (note: here we are not dealing with the relative distance of the finger holes to the mouthpiece, which is of course determined as a function of the tuning, the latter always depending on many factors related to the physical and acoustic configuration of the material used, and requires a determination on a case-by-case basis, as the flute makers always do; we are only dealing here with the lateral ergonomic position relative to the upper and lower axis in the length of the pipe). Ergonomics is therefore defined here as any arrangement in which finger holes are located laterally outside the upper and lower axes of the pipe, with the effect of strengthening instrument balance in the hands of the musician. The following points will develop a highly ergonomic arrangement, that is to say a very marked offset from the axes. This arrangement is not only a contribution to the ease of playing of the new instrument, it is a necessary condition without which it would not be playable in the sense of the practice of a professional musician. This ergonomics is the condition for obtaining a satisfactory dynamic balance of the instrument.

Two Combined Factors: Support and Ergonomic Position of the Fingers

Support

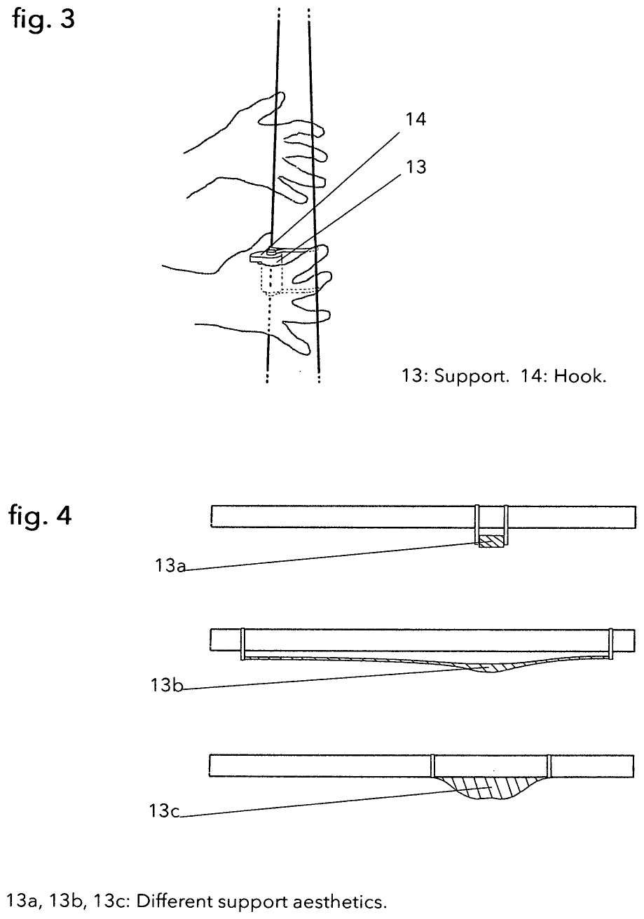

The support is a prop like a rod or a mass fixed to the pipe of the new instrument, which offers a support generally parallel to the pipe, and where the hand's part between the thumb and the index finger of the distant hand comes to place—See the [FIG. 2] of the Drawings section (note: FIG. 2 shows the example of a right-handed set up, with the left hand as close to the mouthpiece and the right hand as distant to the mouthpiece; the result is exactly the same if we reverse the figure from left to right, to represent a left-handed set up; this remark applies to all the figures in the Drawings section). Considering the case of vertical position of the pipe, which is the case of the saxophone type, a hook located at the upper part of the support can be useful to facilitate supporting the instrument's weight—See [FIG. 3] in the Drawings section. In this case of vertical position, moreover, it is possible to exceptionally choose the close hand instead of the distant hand to place the support, the resulting balance being practically equivalent. The whole of our presentation however considers the most appropriate case, namely that of the distant hand for taking up the support.

In principle, in order to release the thumb of the distant hand, there would be several possible supports other than the hollow between the thumb and forefinger, by varying the shape of the support. However, this body part seems to be the best choice, because it is the one that poses the least physical constraint and requires the least effort. This hand part is also that used by violinists with oppositions of forces. The fingers of the left hand, those of the right hand, the palm of the hand under the support, and the lips on the mouthpiece, all of this contribute to create a dynamic balance. Each finger offers a different support on the body of the instrument, and separately opposes a force to all the other supports. It is therefore necessary that each finger or each group of fingers absent at a given moment (when they open the holes) can let the rest of the supports control the balance. This is what the angular reference described in the next section allows.

For a given hole, it is clear that the metric distance of its ergonomic placement relative to the upper axis of the pipe always depends on the diameter of the pipe at this hole position, and as this diameter is variable (depending on the type of instrument considered), this metric distance has no fixed value. What is constant, however, is the angular distance of the placement of this hole, considering the angle which separates the axis of the hole from the vertical axis, relative to the center of the pipe, the upper longitudinal axis of the pipe defined above being placed on this vertical axis—See [FIG. 8] in the Drawings section.

In the play of the instrument, different phalanges of the fingers can be used. Here we keep a very common principle for many keyless wind instruments, namely the use of intermediate phalanges for the index, middle and ring fingers, and distal phalanges for the thumb. and the little finger.

The following model is only a tool, and we should expect possible variations depending on the particular parameters of the size of the players' hands, the choice of phalanges used to cover the holes, the individual preferences, etc. However, it seems important to start from a common reference that has already been tested in musical practice. We therefore present this reference model more in the perspective of being useful for a possible artisanal or industrial reproduction, than to define the innovation of this instrument itself. Indeed, to define the innovative concept, it is sufficient to associate the ergonomic principle with the presence of the support described above.

Angular Reference

To define the ergonomic model, three reference versions must be distinguished their left hand to partially support the weight of the violin, which does not prevent them from developing great dexterity of the fingers of that same hand on the fingerboard.

As the distance of this support extending from the pipe depends on several parameters, in particular the size of the musician's hands and the outside diameter of the pipe, we cannot set out a fixed value. However, we can set out a reference indicating at which angular distance it must be placed in relation to an upper axis conventionally fixed on the pipe, which will be done in point Angular reference (note: the placement of a linear upper axis on the top and in the length of the pipe is conventional and arbitrary, but what matters is that there is a precise geometric relationship between the angular placement of the support and the angular placement of the finger holes, both expressed relative to this conventionally fixed axis).

The aesthetics of the support is not important in itself and can be declined in various forms. It can be like a long rod, a block support, etc. . . . . See [FIG. 4] in the Drawings section.

Ergonomic Finger Position

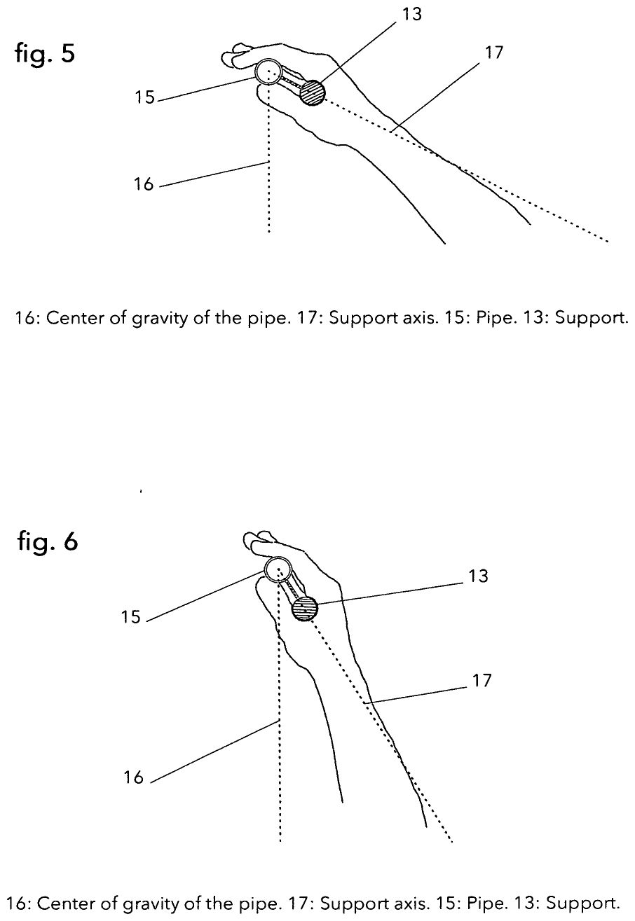

On the new instrument, as the contact of the distant hand on the support determines its position relative to the body of the pipe, the finger holes of this hand must be placed according to this position, and not on an upper axis. If all the fingers—except the thumb—of this hand were to be on the same upper axis, the support would be very off-centered relative to the center of gravity of the pipe—See [FIG. 5] in the Drawings section.

In order to obtain a suitable balance of the instrument with free movements for the fingers, it is necessary to bring this support nearer to the gravity axis of the pipe—See [FIG. 6] in the Drawings section. In this position, therefore, there is an offset between the placement of the holes, lateralized to the right in the figure, and the upper axis of the pipe.

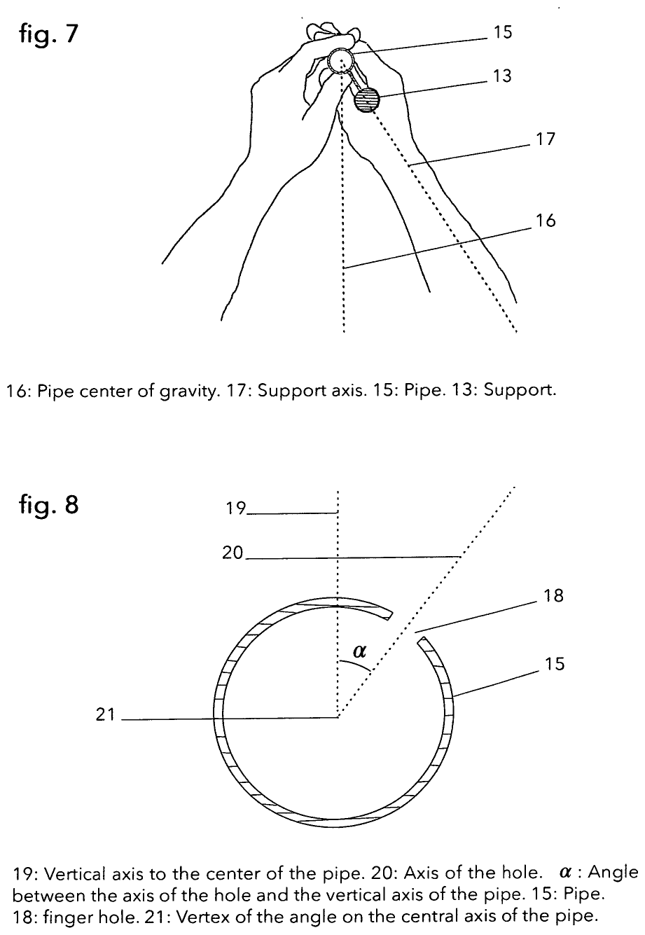

The second hand (the close hand) is naturally placed on the other side with holes also located on the other side of the upper axis of the pipe—See [FIG. 7] in the Drawings section. The placement of the holes for this hand, thus lateralized to the left in the figure, is offset relative to the upper axis of the pipe. The dynamic balance of the instrument is obtained under the effect of several according to whether it is a pipe in vertical position (alto saxophone type), in straight position (soprano saxophone, shakuhachi, kena, etc.), or in transverse position (classical flute, bansuri, dizi, . . . ). The position for these three types is quite different for the two arms, and also in the way the lips contribute to the support. These differences affect arms and hands position relative to each other. The desired balance therefore will not be obtained in the same way in these three different cases.

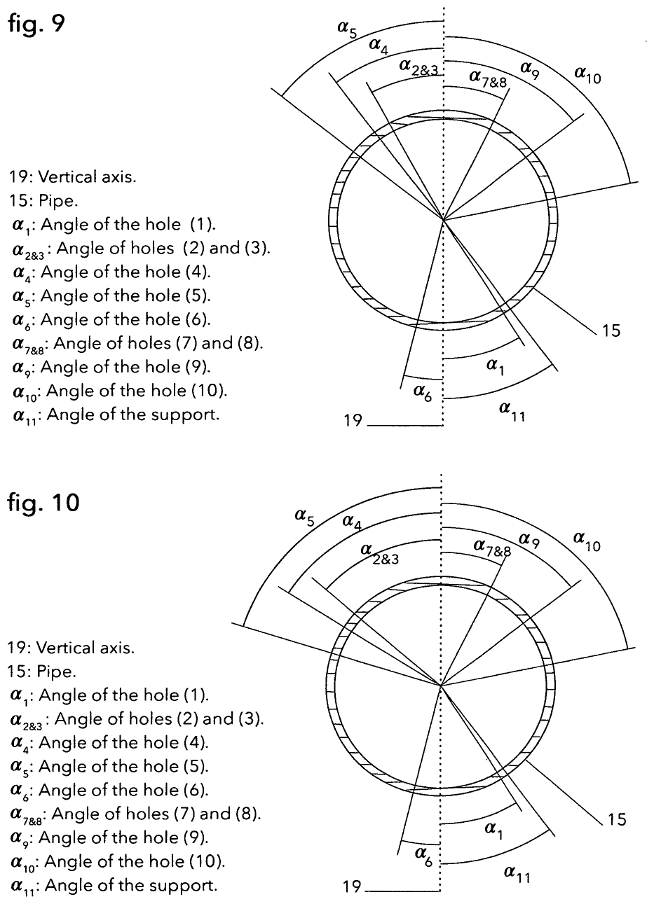

The angles are noted from α1 to α10 and correspond to the finger holes named from (1) to (10) of FIG. 1 in the Drawings section, that is to say with the hole (10) as being furthest from the mouthpiece, and hole (1) as closest to the mouthpiece. The angle formed by the axis of the support with the vertical axis passing through the center of the pipe is noted α₁₁. For clarity reasons, we have chosen to express these angular distances either relative to the upper vertical axis, or relative to the lower vertical axis, depending on whether the axis of the hole considered is closer to it. We also did not make a difference between positive and negative values in the measurement of angles, because the figure speaks for itself considering the lateral positions of the different holes and the support. In FIGS. 9 and 10, the angles of the holes (2) and (3) have the same value because they are placed on the same longitudinal axis, as well as the holes (7) and (8). The case considered here is that of a right-handed set up, with the right hand as being distant from the mouthpiece (note: the reference for a left-handed set up has the same result provided reversing symmetrically from right to left the figures).

Reference for a pipe hold in straight position—See [FIG. 9] of the Drawings and Table 1.

TABLE 1

| Angles | α₁₀ | α₉ | α_{7&8} | α₆ | α₅ | α₄ | α_{2&3} | α₁ | α₁₁ |
|---|---|---|---|---|---|---|---|---|---|
| Angular | 78.4° | 51.8° | 25.7° | 13.4° | 51.4° | 36.7° | 28.1° | 32.0° | 36.0° |
| distance | | | | | | | | | |
| (360°) | | | | | | | | | |

Reference for a pipe hold in transverse position—See [FIG. 10] of the Drawings and Table 2.

TABLE 2

| Angles | α₁₀ | α₉ | α_{7&8} | α₆ | α₅ | α₄ | α_{2&3} | α₁ | α₁₁ |
|---|---|---|---|---|---|---|---|---|---|
| Angular | 78.4° | 51.8° | 25.7° | 13.4° | 72.4° | 57.4° | 48.7° | 32.0° | 36.0° |
| distance | | | | | | | | | |
| (360°) | | | | | | | | | |

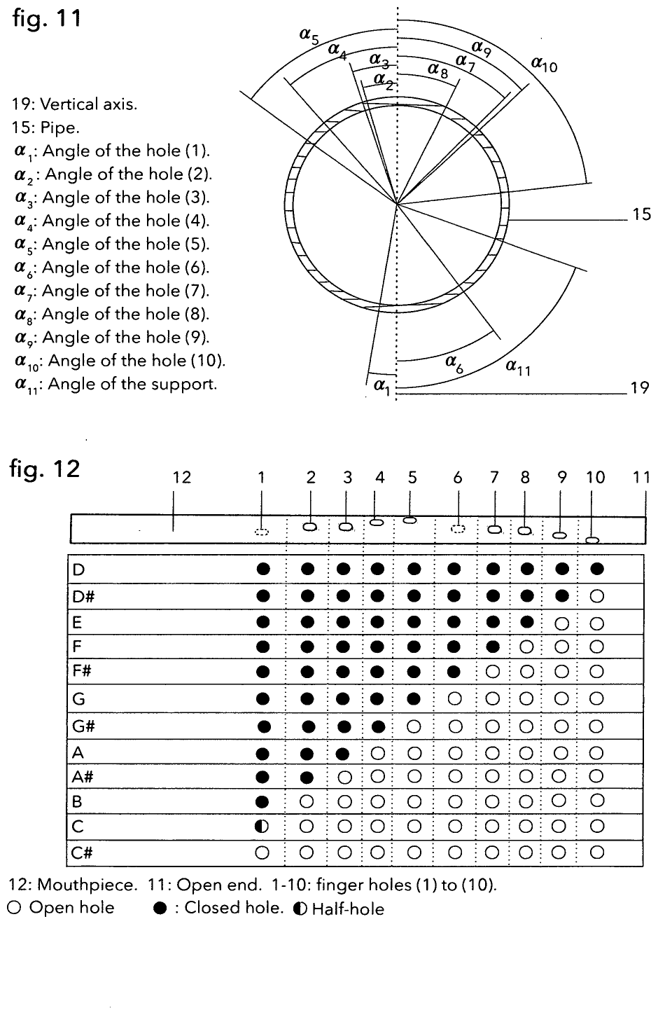

Reference for a pipe hold in vertical position (note: we have taken into account the width and standard taper of the alto saxophone for this reference)—See [FIG. 11] of the Drawings and Table 3.

TABLE 3

| Angles | α₁₀ | α₉ | α₈ | α₇ | ₋α₆ | α₅ | α₄ | α₃ | α₂ | α₁ | α₁₁ |
|---|---|---|---|---|---|---|---|---|---|---|---|
| Angular | 83.5° | 46.8° | 25.7° | 44.4° | 36.6° | 53° | 40.5° | 17.8° | 15.6° | 8.8° | 69.9° |
| distance | | | | | | | | | | | |
| (360°) | | | | | | | | | | | |

### APPENDICES

Ten Fingers for Twelve Semitones, the Solution of the First Register

In the case each finger only control one finger hole, the ten fingers naturally allow playing only eleven of the twelve semitones of the first octave in the first register of the instrument (the ten notes of each of the ten successively open finger holes, plus one note when all these finger holes all closed). We must therefore find a solution to obtain the twelfth semitone of the octave, which is the most suitable for obtaining ease and dexterity in the play.

Playing a half-hole, that is, only partially covering a hole with a finger to obtain a particular pitch, generally becomes a problem of accuracy for musicians only when there are several half-holes to manage in same time, which is the case for example for any traditional flute without keys when one wants to play in a distant tonality from the original tonality of the instrument. However in the case of the new instrument, it is only a question of using the half-hole for a single fingering, a single note out of thirty-six, which in the end is very little restrictive for the dexterity when playing.

Based on this idea, several solutions would be possible, but we propose to choose the half-hole for the thumb of the close hand (close to the mouthpiece—namely the left hand for a right-handed set up), which seems the best for many reasons. On the one hand it is better to choose a note whose opening is close to the mouth (at least above the fifth of the foot of the instrument) to be able to play its octave in the third register, which is by overblowing the fifth of another fingering, because otherwise this half-hole would be repeated an octave higher. In addition, the second problem which can be evoked for the half-hole is often its weakness and its altered tone. However, the acoustic weakness of the half-hole generally becomes a problem when it is done for distant finger holes from the mouthpiece. If, on the other hand, the open hole is chosen near the mouthpiece, where the acoustic power is stronger and the tone more open, it is not difficult to obtain half-hole play which is equal in tone and in dynamic. This is particularly the case with the thumb of the close hand.

To obtain the total chromatic scale of the first octave, we therefore propose the choice exposed in FIG. 12—See [FIG. 12] in the Drawings section.

The Fully Ergonomic Option

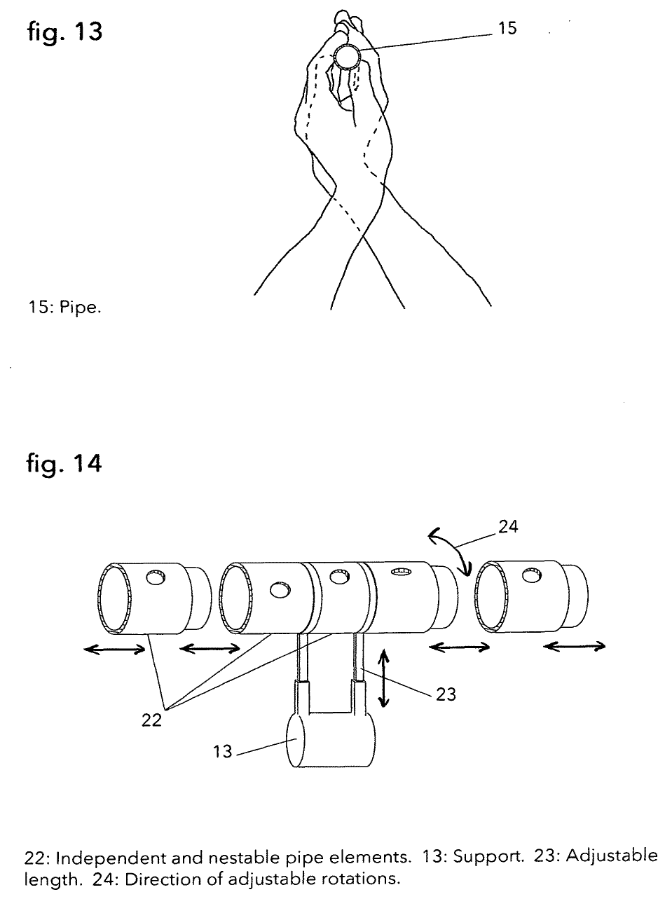

In principle, it would be possible to make this new instrument without any support, based only on a strong ergonomics of the placement of the finger holes. The rule to be used in this sense is that, for any required fingering, regardless of the group of fingers which leave off the contact of the instrument, the rest of the fingers can always control the balance of the pipe. This ergonomics without support gives a particular instrument grip—See [FIG. 13] in the Drawings section. This position, relatively effective for holding the instrument, is unfortunately not at all suitable for the wrists which are permanently extremely streched. To play in this position necessarily leads to overtensions and pain in the hands (note: we confirm this point for having long practiced such a model, among the many experiments that led us to the development of the new instrument). It seems pointless to share such an innovation, therefore this is not the model we are presenting for the new instrument.

Specific Tool Dedicated to the Instrument Maker

This specific tool is is a diversely articulated pipe whose utility for the instrument maker is to quickly determine what precise ergonomics one should use to build the instrument dedicated to a particular player. It is an individually adjustable model according to the musicians' hands. It consists of a set of ten sections of pipe fitted into each other, each portion including a finger hole, and every section can freely rotate relative to each other (note: the spacing of these sections would ideally be also adjustable; in practice, at least the spacing must be as close as possible to the real distances of an already adjusted instrument which serves as a reference). This tool also has an adjustable length support, for the grip of the distant hand—See [FIG. 14] in the Drawings section.

With such a tool, depending on the size of the musician's hands and the choice of phalanges used to cover the holes, it is possible for the instrument maker to determine with precision the ergonomic model and the support size to be built for the particular instrument. The tool itself does not have any acoustic quality, and the musician does not need to blow into it. He just needs to feel in which position of the arms, hands, fingers and contact with the mouthpiece, he is the most comfortable to hold the new instrument and have an easy finger playing.

Industrial Reproduction Perspective

An practical and documented study, relating a significant number of individual cases concerning the different possible hand morphologies, would be necessary to confirm the following point. However, the limited but already significant experience we have allows us to point out a research direction.

Although the ergonomics of the placement of the finger holes ideally should be adapted individually, it is likely that a relatively limited range of possible configurations of this ergonomics is sufficient to satisfy all the individual cases. Firstly, the support of an industrial version of the new instrument must be adjustable, both in angle to the pipe and in distance with it; this is the first point, which makes no technical difficulty. Then, whatever its size, once a player's hand take on the support it adjusts so that the thumb-index-support grip is easy and comfortable. This does not make either difficulties since the support must be adjustable in length. From there, choosing the middle phalange of the index finger for controling the hole, it is very likely that the neighboring middle finger can with its middle phalange also control a hole located on the same longitudinal axis as the index hole. Indeed these phalanges have possibly used areas (area outside the articulation areas) very concomitants, especially if the forearms are placed slightly oblique to the pipe, which is obviously the desirable position for the forearms (see [FIG. 1]).

This observation applies in the same way for the proximal hand, with the additional facility that the absence of support for this hand leaves it free to reach the holes intended for its thumb, its index and its middle finger, and this probably whatever its morphology looks like. In fact, the support points that we have just described, namely the thumb-index-middle groups of the two hands, are the main support points of the ergonomic concept described above, and are already sufficient to control the general balance of the instrument. So it is likely that the relation of the angular distances (as defined in the point Angular Reference) of these groups of holes is invariant in an industrial version of the new instrument. The only necessary variation is probably that of the ergonomics of the four finger holes corresponding to the ring finger and the little finger of both hands. Several versions should be provided with a more or less marked fan shaped offset of these finger holes placement compared to the model exposed in this presentation, so that it can be used by hands of very different morphology. According to our experience, it seems that less than ten variants would probably be enough to cover a range in which any musician, whatever the morphology of his hand, can find a version on which he can play (note: this point is all the more likely as the way of using the phalanges for every player is free; as it is possible to cover the finger holes with different parts of the same phalange, depending on whether one places the phalange more at the top or more towards the base, this offers multiple possible combinations to allow the fingers to match a given configuration of holes). In this sense, we could think to a limited number of fixed models, to which we could give the name of letters or numbers, as for all the variations that exist for example for the opening tip of the saxophone mouthpieces. A practical study would be necessary to determine in detail these different versions.

FIG. 1 represents the anatomical continuity of the instrument fingering.

FIG. 2 represents the support.

FIG. 3 represents the support for an instrument hold in vertical position.

FIG. 4 represents different aesthetics of support.

FIG. 5 represents a position of the support relative to the center of gravity of the instrument.

FIG. 6 represents a position of the support relative to the center of gravity of the instrument.

FIG. 7 represents the position of the support relative to the center of gravity of the instrument, with both hands.

FIG. 8 represents the angular distance of a finger hole.

FIG. 9 represents the set of angular distances of the ten finger holes for a pipe hold straight position.

FIG. 10 represents the set of angular distances of the ten finger holes for a pipe hold in transverse position.

FIG. 11 represents the set of angular distances of the ten finger holes for a pipe hold in vertical position.

FIG. 12 represents the fingering chart proposed for the new instrument.

FIG. 13 represents a particular position of the hands.

FIG. 14 represents the fragment of a tool dedicated to the instrument maker.

1. A single pipe musical wind instrument configuration for playing all semitones over three octaves, the instrument configuration comprising: a pipe (15); a mouthpiece (12); an open end (11); a support (13); and ten finger holes named from (1) to (10) placed successively in strictly increasing distance relative to the mouthpiece (12), so that, if all the considered angular vertices are located on the central axis of the pipe (21), and if all half-lines (20) are perpendicular to the central axis of the pipe (21), the angle (α₅) being formed by the half-line passing through the center of the hole (5) and the vertical axis (19), the angle (α₁₀) being formed by the half-line passing through the center of the hole (10) and the vertical axis (19), the sum of the absolute values of these angle measurements (α₅) and (α₁₀) has a value between 70° and 190°.

2. An instrument configuration as in claim 1, wherein said support (13) is formed by a prominence coming out of the pipe (15) dedicated to the grip of one hand in the hollow between the thumb and forefinger.

3. An instrument configuration as in claim 1, wherein said support (13) is a harness attached to the pipe (15).
